(19) United States
(12) Patent Application Publication
(10) Pub. No.: US 2026/0098146 A1
(43) Pub. Date: Apr. 9, 2026

(54) RUBBER COMPOSITION AND TIRE

(71) Applicant: Toyo Tire Corporation, Itami-shi (JP)

(72) Inventor: Shuhei Yamamoto, Itami-shi (JP)

(73) Assignee: Toyo Tire Corporation, Itami-shi (JP)

(21) Appl. No.: 19/332,490

(22) Filed: Sep. 18, 2025

(30) Foreign Application Priority Data
Oct. 7, 2024 (JP) 2024-175887

(51) Int. Cl. C08L 17/00; B60C 1/00

(52) U.S. Cl. CPC C08L 17/00; B60C 1/0016; B60C 1/0025; C08L 2205/02

(57) ABSTRACT

Provided is a rubber composition containing an unvulcanized rubber component and 0.1 to 30 parts by mass of a reclaimed rubber containing a styrene-butadiene rubber relative to 100 parts by mass of the unvulcanized rubber component. The reclaimed rubber has an amount of chloroform-extractable matter by Soxhlet extraction of 15 to 30 mass %, the chloroform-extractable matter contains an oil and a thermoplastic resin, and the reclaimed rubber has a toluene solubility of 25 mass % or more.

### BACKGROUND OF THE INVENTION

### 1. Field of the Invention

The present invention relates to a rubber composition and a tire using the same.

### 2. Description of Related Art

In view of waste disposal and effective use of resources, the reclamation of styrene-butadiene rubber (SBR)-based rubber vulcanizates, mainly from tires for passenger cars, is under vigorous study (see JP2023-546450A; JP2018-076507A; KAWASAKI, Hitoshi, and 3 other authors, “Simplified method for reclaiming styrene butadiene rubber compound”, Journal of the Society of Rubber Science and Technology, Japan, Vol. 48, No. 4, 1975, pp. 74-81; and KAWABATA, Nariyoshi, and 2 other authors, “Simple reclamation of carbon black stock vulcanizates of synthetic rubbers by the copper (I) chloride-tributylamine system”, Journal of the Society of Rubber Science and Technology, Japan, Vol. 52, No. 11, 1979, pp. 83-92). However, SBR-based rubber vulcanizates are difficult to reclaim in the same process as natural rubber (NR)-based rubber vulcanizates.

A known method for producing reclaimed rubbers is the oil-pan process, which involves treatment using a reclaiming agent and an oil at a high temperature of about 200° C. to facilitate plasticization. NR-based rubber vulcanizates are plasticized by the oil-pan process to produce reclaimed rubbers, of which the material strength is not the same as those of the original vulcanized rubbers, but is still sufficient to provide products for practical use in some applications. On the other hand, when SBR-based rubber vulcanizates are subjected to the oil-pan process for reclamation, they gel and cure due to the properties of SBRs and are thus considered difficult to recycle. Therefore, SBR-containing reclaimed rubbers, which are formed by reclamation of SBR-based rubber vulcanizates, are hardly distributed in the market. In the current circumstances, SBR-based rubber vulcanizates are often micronized to a size of 100 μm or less without heat and used as fine powder. However, the use of such fine powder is known to result in deterioration in various physical properties such as mechanical properties.

### SUMMARY OF THE INVENTION

As described above, SBR-based rubber vulcanizates have not been recycled as reclaimed rubbers as commonly as NR-based rubber vulcanizates. In order to promote the recycling of SBR-based rubber vulcanizates, there is a need to improve the mechanical properties, including breaking strength and elongation at break, of a rubber composition using a reclaimed rubber derived from SBR-based rubber vulcanizates.

In consideration of the above, an object of embodiments of the invention is to improve the breaking strength and elongation at break of a rubber composition using an SBR-containing reclaimed rubber.

The invention includes embodiments shown below.

[1] A rubber composition containing 0.1 to 30 parts by mass of a reclaimed rubber containing a styrene-butadiene rubber relative to 100 parts by mass of an unvulcanized rubber component, wherein the reclaimed rubber has an amount of chloroform-extractable matter by Soxhlet extraction of 15 to 30 mass %, the chloroform-extractable matter containing an oil and a thermoplastic resin, and wherein the reclaimed rubber has a toluene solubility of 25 mass % or more.
[2] The rubber composition according to the above [1], wherein a rubber polymer in the reclaimed rubber have a styrene content of 10% to 60% in terms of peak area percentage as determined by pyrolysis-gas chromatography in accordance with JIS K 6231-2:2007.
[3] The rubber composition according to the above [2], wherein the rubber polymer in the reclaimed rubber have a butadiene content of 15% to 60% in terms of peak area percentage as determined by pyrolysis-gas chromatography in accordance with JIS K 6231-2:2007.
[4] The rubber composition according to the above [2] or [3], wherein the rubber polymer in the reclaimed rubber have an isoprene content of 0% to 50% in terms of peak area percentage as determined by pyrolysis-gas chromatography in accordance with JIS K 6231-2:2007.
[5] The rubber composition according to any one of the above [1] to [4], further containing 20 to 150 parts by mass of a reinforcing filler relative to 100 parts by mass of the unvulcanized rubber component.
[6] The rubber composition according to any one of the above [1] to [5], wherein the thermoplastic resin is at least one tackifier resin selected from the group consisting of cumarone-based resin, petroleum resin, terpene-based resin, and rosin-based resin.
[7] The rubber composition according to any one of the above [1] to [6], wherein the reclaimed rubber has a rubber polymer content of 30 to 60 mass % as determined by thermogravimetric analysis (TGA).
[8] The rubber composition according to the above [7], wherein the reclaimed rubber has a carbon black content of 3 to 20 mass % as determined by thermogravimetric analysis (TGA).
[9] The rubber composition according to the above [7] or [8], wherein the reclaimed rubber has an ash content of 10 to 35 mass % as determined by thermogravimetric analysis (TGA).
[10] The rubber composition according to any one of the above [1] to [9], wherein the 100 parts by mass of the unvulcanized rubber component include 20 to 100 parts by mass of a styrene-butadiene rubber.
[11] The rubber composition according to any one of the above [1] to [9], wherein the 100 parts by mass of the unvulcanized rubber component include 50 to 90 parts by mass of a styrene-butadiene rubber and 10 to 50 parts by mass of a natural rubber and/or a butadiene rubber.
[12] A tire having a vulcanized rubber formed by vulcanization of the rubber composition according to any one of the above [1] to [11].

According to an embodiment of the invention, improvement in the breaking strength and elongation at break of a rubber composition using an SBR-containing reclaimed rubber can be achieved.

### BRIEF DESCRIPTION OF THE DRAWINGS

FIG. 1 is a graph illustrating a method for determining the amount of chloroform-extractable matter.

### DESCRIPTION OF EMBODIMENTS

A rubber composition according to embodiments of the invention contains an unvulcanized rubber component blended with a reclaimed rubber containing a styrene-butadiene rubber. The reclaimed rubber used contains 15 to 30 mass % of chloroform-extractable matter separated by Soxhlet extraction, the chloroform-extractable matter contains an oil and a thermoplastic resin, and the reclaimed rubber has a toluene solubility of 25 mass % or more. The oil and the thermoplastic resin serve as reclaiming agents (devulcanizing agents) and facilitate the reclamation of rubber vulcanizates. Controlling the amount of the chloroform-extractable matter containing an oil and a thermoplastic resin within the above specific range and adjusting the toluene solubility to 25 mass % or more suppress the gelation of the styrene-butadiene rubber. This allows for improved miscibility of the reclaimed rubber and the unvulcanized rubber component, enabling improvement in mechanical properties such as breaking strength and elongation at break.

In embodiments of the invention, a reclaimed rubber containing a styrene-butadiene rubber (SBR) is used as the reclaimed rubber. Specifically, a reclaimed rubber formed by reclamation of an SBR-based rubber vulcanizate, which is an SBR-containing vulcanized rubber, is used. As used herein, the reclaimed rubber refers to a material formed by reclamation of vulcanized rubbers, more particularly, a material formed by physical and/or chemical treatment of vulcanized rubbers to render the material tacky and plastic again.

The SBR-based rubber vulcanizate is a rubber containing an SBR as a rubber polymer and obtained by vulcanization with a vulcanizing agent such as sulfur. The SBR may be a solution polymerized styrene-butadiene rubber (SSBR) or an emulsion polymerized styrene-butadiene rubber (ESBR), or a combination thereof. The amount of the SBR is preferably 20 mass % or more, more preferably 50 mass % or more, still more preferably 70 mass % or more, or may be even 100 mass % (that is, the SBR alone) relative to 100 mass % of the rubber polymer. Preferable examples of a rubber polymer used in combination with the SBR include a diene rubber such as a natural rubber (NR), a synthetic isoprene rubber (IR), and/or a butadiene rubber (BR). The rubber polymer may be a non-modified rubber, or a modified rubber having a modified structure such as a modified end or main chain.

The SBR-based rubber vulcanizate may contain a reinforcing filler such as carbon black or silica. In this case, the reclaimed rubber also contains the reinforcing filler. The amount of the reinforcing filler in the SBR-based rubber vulcanizate is not particularly limited, and may be 20 to 150 parts by mass, 40 to 120 parts by mass, or 50 to 100 parts by mass relative to 100 parts by mass of the rubber polymer.

The SBR-based rubber vulcanizate may contain an oil. In this case, the reclaimed rubber also contains the oil. The amount of the oil in the SBR-based rubber vulcanizate is not particularly limited, and may be 0 to 50 parts by mass or 5 to 40 parts by mass relative to 100 parts by mass of the rubber polymer.

An unvulcanized rubber composition used for the production of the SBR-based rubber vulcanizate may contain various additives commonly used in rubber compositions, including, for example, zinc oxide, stearic acid, age-resisters, waxes, silane coupling agents, and vulcanization accelerators, in addition to the above-mentioned rubber polymer, vulcanizing agent, reinforcing filler, and oil. This means that the SBR-based rubber vulcanizate may contain these additives and/or reaction products thereof. The reclaimed rubber also may contain these additives and/or reaction products thereof.

The reclamation of the SBR-based rubber vulcanizate is preferably performed using the oil-pan process. More particularly, a reclaimed rubber may be prepared by grinding the SBR-based rubber vulcanizate into powdered rubber in advance, mixing the powdered rubber with a reclaiming agent, and heating and pressurizing the mixture in a steam atmosphere.

Examples of the reclaiming agent include oils, peptizers, and thermoplastic resins. One or more of these reclaiming agents may be used. Preferably, these three reclaiming agents are used. The reclamation process in the presence of a thermoplastic resin as well as an oil and a peptizer more effectively suppresses the gelation of the SBR and can produce a well-cohesive reclaimed rubber. This is probably because the thermoplastic resin, which softens with heat, renders the reclaimed rubber tacky and suppresses the gelation of the SBR.

Examples of the oil added as the reclaiming agent include mineral oils such as paraffinic oil, naphthenic oil, and aromatic oil, and plant-derived oils such as turpentine oil. Any one of these oils or a combination of two or more of them can be used.

Examples of the peptizer added as the reclaiming agent include aromatic disulfides such as diphenyl disulfide and 2,2-dibenzamidiphenyl disulfide

Examples of the thermoplastic resin added as the reclaiming agent include tackifier resins such as cumarone-based resins, petroleum resins, terpene-based resins, and rosin-based resins. Any one of these thermoplastic resins or a combination of two or more of them can be used. The thermoplastic resin preferably has a softening point of 50° C. to 130° C., more preferably 70° C. to 120° C. The softening point of the resin is measured using a ring-and-ball softening point tester in accordance with JIS K 6220-1:2015.

The cumarone-based resins are resins containing a cumarone as a constituent monomer and include, for example, cumarone resins and cumarone-indene resins. The petroleum resins include, for example, aliphatic petroleum resins (C5 petroleum resins), aromatic petroleum resins (C9 petroleum resins), and aliphatic-aromatic copolymer petroleum resins (C5/C9 petroleum resins). The terpene-based resins are resins formed by polymerization of terpene compounds such as α-pinene, β-pinene, limonene, and dipentene, and have units derived from terpene compounds. The terpene-based resins may be polyterpene resins obtained by polymerization of terpene monomers alone, or modified terpene resins (e.g., terpene phenolic resins) obtained by polymerization of terpene compounds and monomers other than terpenes. The rosin-based resins include, for example, rosin as a natural resin and rosin-modified resins (e.g., hydrogenated rosin esters and rosin-modified maleic resins) formed from rosin as a natural resin by hydrogenation, disproportionation, dimerization, esterification, etc. Among these resins, cumarone-based resins are preferably used as the thermoplastic resin.

The amounts of the oil, peptizer, and thermoplastic resin each added as the reclaiming agent to the SBR-based rubber vulcanizate are not particularly limited as long as the reclaimed rubber obtained by reclamation of the SBR-based rubber vulcanizate contains 15 to 30 mass % of the chloroform-extractable matter. For example, the amount of the oil added as the reclaiming agent may be 0 to 10 parts by mass or 2 to 7 parts by mass relative to 100 parts by mass of the SBR-based rubber vulcanizate. The amount of the peptizer added as the reclaiming agent may be 0 to 3 parts by mass or 0.5 to 2 parts by mass relative to 100 parts by mass of the SBR-based rubber vulcanizate. The amount of the thermoplastic resin added as the reclaiming agent may be 1 to 15 parts by mass or 5 to 12 parts by mass relative to 100 parts by mass of the SBR-based rubber vulcanizate. In the case where the SBR-based rubber vulcanizate originally contains an oil, a peptizer, or a thermoplastic resin, their respective amounts may be taken into consideration in adjusting the amounts of the oil, peptizer, and thermoplastic resin each added as the reclaiming agent. That is, the amounts of the oil, peptizer, and thermoplastic resin in the chloroform-extractable matter include not only the amounts of the oil, peptizer, and thermoplastic resin each added as the reclaiming agent, but also their amounts originally contained in the SBR-based rubber vulcanizate as long as they remain in the reclaimed rubber.

Heating and pressurizing a mixture of the powdered rubber and the reclaiming agent may be performed, for example, using an autoclave in a steam atmosphere at a temperature of 150° C. to 300° C. at a pressure of 0.2 to 2.0 MPa for 1 to 6 hours.

In embodiments of the invention, the SBR-containing reclaimed rubber used is a reclaimed rubber having an amount of chloroform-extractable matter by Soxhlet extraction of 15 to 30 mass %. The chloroform-extractable matter is a component extracted with chloroform by Soxhlet extraction. The chloroform-extractable matter is chloroform-soluble ingredients and contains an oil and a thermoplastic resin. When the amount of the chloroform-extractable matter containing an oil and a thermoplastic resin is 15 to 30 mass %, the reclaimed rubber, despite containing an SBR, has improved miscibility with the unvulcanized rubber component and can contribute to improvement in breaking strength and elongation at break. The amount of the chloroform-extractable matter is preferably 17 to 29 mass %, more preferably 18 to 28 mass %, still more preferably 19 to 25 mass %, and even more preferably 20 to 23 mass %. The method for determining the amount of the chloroform-extractable matter is as described in the section of Examples.

The ratio of the oil and the thermoplastic resin in the reclaimed rubber is not particularly limited, and for example, the oil/thermoplastic resin ratio on a mass basis may be 1/3 to 4/1, 1/2 to 3/1, or 2/3 to 2/1.

The reclaimed rubber may not contain a peptizer because the peptizer is consumed in the reaction with the rubber polymer in the step for reclaiming an SBR-based rubber vulcanizate, but the reclaimed rubber may contain part of an unreacted fraction of the peptizer in the chloroform-extractable matter. The chloroform-extractable matter contains an oil and a thermoplastic resin as main components, and for example, the total amount of the oil and the thermoplastic resin may be 80 mass % or more, 90 mass % or more, or 100 mass % in 100 mass % of the chloroform-extractable matter. The chloroform-extractable matter may contain other additives such as age-resisters.

In embodiments of the invention, the SBR-containing reclaimed rubber used has a toluene solubility of 25 mass % or more. The toluene solubility is also referred to as sol fraction. A higher sol fraction indicates a higher degree of devulcanization, leading to improved miscibility with the unvulcanized rubber component and improved breaking strength and elongation at break. The reclaimed rubber preferably has a toluene solubility of 27 mass % or more. The upper limit of the toluene solubility is not particularly specified. The toluene solubility may be, for example, 50 mass % or less or 40 mass % or less. The method for determining toluene solubility is as described in the section of Examples.

The reclaimed rubber contains an SBR as a rubber polymer as described above. The styrene content in the rubber polymer in the reclaimed rubber, which indicates the SBR content, is preferably 10% to 60% in terms of peak area percentage as determined by pyrolysis-gas chromatography in accordance with JIS K 6231-2:2007. The styrene content is more preferably 15% to 50%. The butadiene content in the rubber polymer is preferably 15% to 60% and more preferably 20% to 50% in terms of peak area percentage as determined in the same manner. The isoprene content in the rubber polymer is preferably 0% to 50% and more preferably 20% to 40% in terms of peak area percentage as determined in the same manner.

The method for determining these peak area percentages is as described in the section of Examples.

The rubber polymer content in the reclaimed rubber in mass percentage as determined by thermogravimetric analysis (TGA) in accordance with JIS K 6226-1:2003 is preferably 30 to 60 mass % and more preferably 40 to 50 mass %. The carbon black content in the reclaimed rubber as determined by TGA in the same manner may be, for example, 3 to 20 mass % or 5 to 10 mass %. The ash content in the reclaimed rubber as determined by TGA in the same manner may be, for example, 10 to 35 mass % or 15 to 30 mass %. The ash contains inorganic ingredients such as silica and zinc compounds such as zinc oxide. The method for determining these mass percentages is as described in the section of Examples.

The unvulcanized rubber component in the rubber composition according to embodiments of the invention is not particularly limited, and examples thereof include a diene rubber such as a natural rubber (NR), a synthetic isoprene rubber (IR), a styrene-butadiene rubber (SBR), and a butadiene rubber (BR). Any one of these rubbers or a combination of two or more of them can be used. The diene rubber refer to a rubber having a repeating unit corresponding to a diene monomer having a conjugated double bond and contains a carbon-carbon double bond in the main chain of the polymer. The diene rubber may be a non-modified rubber, or a modified rubber having a modified structure such as a modified end or main chain.

In one embodiment, the unvulcanized rubber component preferably includes an SBR. The SBR may be an SSBR or an ESBR, or a combination thereof. For example, the 100 parts by mass of the unvulcanized rubber component preferably include an SBR in an amount of 20 parts by mass or more, more preferably 50 parts by mass or more, and still more preferably 70 parts by mass or more. Alternatively, the unvulcanized rubber component may include an NR and/or a BR in combination with an SBR. For example, the 100 parts by mass of the unvulcanized rubber component may include 50 to 90 parts by mass of an SBR and 10 to 50 parts by mass of an NR and/or a BR, or 65 to 85 parts by mass of an SBR and 15 to 35 parts by mass of an NR and/or a BR.

The rubber composition according to embodiments of the invention contains 0.1 to 30 parts by mass of the reclaimed rubber relative to 100 parts by mass of the unvulcanized rubber component. The amount of the reclaimed rubber is preferably 1 to 30 parts by mass, more preferably 5 to 25 parts by mass, and still more preferably 10 to 20 parts by mass relative to 100 parts by mass of the unvulcanized rubber component.

Preferably, the rubber composition according to embodiments of the invention further contains a reinforcing filler. The amount of the reinforcing filler is preferably 20 to 150 parts by mass relative to 100 parts by mass of the unvulcanized rubber component. The amount of the reinforcing filler is more preferably 40 to 120 parts by mass, and still more preferably 50 to 100 parts by mass. As used herein, the amount of the reinforcing filler excludes the amount of the reinforcing filler contained in the reclaimed rubber.

The reinforcing filler contained in the rubber composition is preferably carbon black and/or silica. Examples of the silica include wet silica and dry silica. Preferably, wet silica such as wet-precipitated silica and wet-gelled silica is used. The amount of the silica is not particularly limited, and may be 20 to 140 parts by mass, 30 to 110 parts by mass, or 40 to 90 parts by mass relative to 100 parts by mass of the unvulcanized rubber component. The amount of the carbon black is not particularly limited, and may be 0 to 100 parts by mass, 5 to 50 parts by mass, or 10 to 30 parts by mass relative to 100 parts by mass of the unvulcanized rubber component.

The rubber composition according to embodiments of the invention may contain various additives commonly used in rubber compositions, including, for example, silane coupling agents, oils, zinc oxide, stearic acid, age-resisters, waxes, vulcanizing agents such as sulfur, and vulcanization accelerators, in addition to the above-mentioned unvulcanized rubber component, reclaimed rubber, and reinforcing filler.

The amounts of these additives are not particularly limited, and their amounts in typical rubber compositions are applicable. For example, the amount of the silane coupling agent may be 3 to 20 parts by mass or 5 to 15 parts by mass relative to 100 parts by mass of the silica. The amount of the oil may be 5 to 50 parts by mass or 10 to 30 parts by mass relative to 100 parts by mass of the unvulcanized rubber component. The amount of the zinc oxide may be 0 to 10 parts by mass, 0.5 to 5 parts by mass, or 1 to 4 parts by mass relative to 100 parts by mass of the unvulcanized rubber component. The amount of the stearic acid may be 0 to 10 parts by mass, 0.5 to 5 parts by mass, or 1 to 4 parts by mass relative to 100 parts by mass of the unvulcanized rubber component. The amount of the age-resister may be 0 to 10 parts by mass, 0.5 to 5 parts by mass, or 1 to 4 parts by mass relative to 100 parts by mass of the unvulcanized rubber component. The amount of the vulcanizing agent may be 0.1 to 10 parts by mass, 0.5 to 5 parts by mass, or 1 to 3 parts by mass relative to 100 parts by mass of the unvulcanized rubber component. The amount of the vulcanization accelerator may be 0.1 to 10 parts by mass, 1 to 7 parts by mass, or 2 to 5 parts by mass relative to 100 parts by mass of the unvulcanized rubber component.

The rubber composition according to embodiments of the invention can be produced by kneading the ingredients using a commonly used mixer such as a Banbury mixer, a kneader, or a roll in the usual manner. That is, for example, the rubber components are mixed with additives excluding a vulcanizing agent and a vulcanization accelerator in the first mixing step, and the mixture is then mixed with the vulcanizing agent and the vulcanization accelerator in the final mixing step, so that the rubber composition can be prepared.

The rubber composition according to embodiments of the invention can be used for various rubber products such as tires, anti-vibration rubbers, and conveyor belts, and is preferably used for tires. The tires include pneumatic tires for various applications and in various sizes such as tires for passenger cars and large tires for trucks and buses (heavy duty tires). Preferably, the rubber composition is used for tires for passenger cars because it contains an SBR. Parts of a tire to which the rubber composition is applicable include, for example, tread rubber and sidewall rubber.

The rubber composition is, for example, extruded into a predetermined shape and heated for vulcanization in the usual manner, thereby forming a vulcanized rubber. For use in pneumatic tires, the rubber composition is extruded or otherwise to be formed into a predetermined shape and assembled with other parts to produce green tires. The green tires are then vulcanized and molded, for example, at 130° C. to 190° C. Thus, pneumatic tires having rubber parts containing a vulcanized rubber formed from the rubber composition can be produced.

### EXAMPLES

Hereinafter, examples of the invention are provided, but the invention is not limited thereto.

### Preparation of Reclaimed Rubbers

### 1. Preparation of Vulcanizates 1 and 2

Rubber compositions were prepared according to the formulation (parts by mass) shown in Table 1 below using a Banbury mixer. More particularly, compounding ingredients excluding sulfur and vulcanization accelerators were added to the rubber polymer and kneaded. Then, sulfur and vulcanization accelerators were added to the kneaded mixture and kneaded to prepare rubber compositions. Then, the obtained rubber compositions were separately vulcanized at 160° C. for 20 minutes to give vulcanizates 1 and 2.

TABLE 1

| | Parts by | | Parts by |
|---|---|---|---|
| Vulcanizate 1 | mass (phr) | Vulcanizate 2 | mass (phr) |
| SBR-1 | 40 | SBR-1 | 28 |
| SBR-2 | 60 | SBR-3 | 38 |
| Carbon black N339 | 15 | SBR-4 | 19.3 |
| Silica | 50 | NR | 20 |
| Silane coupling agent | 4 | Stearic acid | 2 |
| Process oil | 10 | Carbon black ISAF | 4 |
| Stearic acid | 2 | Silica | 80 |
| Zinc oxide | 2 | Process oil | 25 |
| Vulcanization | 1.8 | Silane coupling | 5 |
| accelerator A | | agent | |
| Vulcanization | 1.3 | Zinc oxide | 2 |
| accelerator B | | | |
| Sulfur | 1.8 | Vulcanization | 2.2 |
| | | accelerator A | |
| | | Vulcanization | 1.8 |
| | | accelerator B | |
| | | Sulfur | 1.8 |

Each ingredient in Table 1 is as follows.
SBR-1: Non-modified ESBR, “SBR 1502” manufactured by ENEOS Materials Corporation
SBR-2: End-modified SSBR, “HPR 350” manufactured by ENEOS Materials Corporation
SBR-3: End-modified SSBR, “HPR 355” manufactured by ENEOS Materials Corporation
SBR-4: Non-modified SSBR, “TUFDENE 1834” (37.5 phr oil-extended rubber) manufactured by Asahi Kasei Corp.
NR: RSS #3
Carbon black N339: “DIABLACK N339” manufactured by Mitsubishi Chemical Group Corporation
Carbon black ISAF: “SEAST 6” manufactured by Tokai Carbon Co., Ltd.
Silica: “TOKUSIL USG-A” manufactured by OSC Siam Silica Co., Ltd.
Silane coupling agent: “Si 75” manufactured by Evonik Japan Co., Ltd.
Process oil: “Process NC-140” manufactured by ENEOS Corporation
Stearic acid: “Stearic acid N-50” manufactured by NOF Corporation
Zinc oxide: “Zinc oxide grade 2” manufactured by Mitsui Mining & Smelting Co., Ltd.
Vulcanization accelerator A: “SOXINOL D-G” manufactured by Sumitomo Chemical Co., Ltd.
Vulcanization accelerator B: “Nocceler CZ-G” manufactured by Ouchi Shinko Chemical Industrial Co., Ltd.
Sulfur: “Oil treated sulfur 150-mesh powder” manufactured by Tsurumi Chemical Industry Co., Ltd.

### 2. Preparation of Powdered Rubbers 1 and 2

Vulcanizates 1 and 2 were separately crushed into a size of about 2 to 3 mm cubes using a primary crusher, Universal Cutting Mill P-19 manufactured by Fritsch Japan Co., Ltd. The crushed powder materials were ground into a 30-mesh or smaller size using a freezer mill to give powdered rubbers 1 and 2. The freezer mill used was CryoMill 100-240V 50/60 Hz manufactured by Verder Scientific GmbH & Co. KG.

### 3. Preparation of Reclaimed Rubber 1

To 100 parts by mass of powdered rubber 1, 5 parts by mass of a process oil (“Process NC-140” manufactured by ENEOS Corporation), 1 part by mass of diphenyl disulfide, and 10 parts by mass of a cumarone resin (“PS-65” manufactured by NITTO CHEMICAL CO., LTD.) were added and mixed. The mixture was placed into a 300-cc autoclave and devulcanized in a steam atmosphere at a temperature of about 200° C. at a pressure of 1.67 MPa for 3 hours. After the devulcanization, the devulcanized product was sheeted using a roll. Thus, reclaimed rubber 1 was obtained.

### 4. Preparation of Reclaimed Rubber 2

Reclaimed rubber 2 was obtained in the same manner as in the preparation procedure for reclaimed rubber 1 except that powdered rubber 2 was used instead of powdered rubber 1.

### 5. Preparation of Reclaimed Rubber 3

Reclaimed rubber 3 was obtained in the same manner as in the preparation procedure for reclaimed rubber 1 except that the devulcanization time was changed from 3 hours to 6 hours.

### 6. Preparation of Reclaimed Rubber 4

Reclaimed rubber 4 was obtained in the same manner as in the preparation procedure for reclaimed rubber 1 except that the cumarone resin was not added.

### Analysis of Reclaimed Rubbers

Reclaimed rubbers 1 to 4 and powdered rubbers 1 and 2 were subjected to determination of the amount of chloroform-extractable matter (hereinafter also referred to as chloroform-extractable content), toluene solubility (sol fraction), and rubber polymer composition. The respective determination procedures are as follows.

### 1. Chloroform-Extractable Content

Reclaimed rubbers 1 to 4 and powdered rubbers 1 and 2 were used as samples and analyzed in accordance with JIS K 6226-1:2003 “Rubber and rubber products-Determination of the composition of vulcanizates and uncured compounds by thermogravimetry”.

More particularly, chloroform-soluble ingredients were extracted using an automatic Soxhlet extractor (“E-800” manufactured by Nihon BUCHI K.K.). Extraction conditions were as specified in JIS K 6229:2015, under which 2 g of a sample was treated with a solvent chloroform at 90° C. for 8 hours.

Then, 10 mg each of an extraction-treated sample, which was a sample subjected to chloroform extraction, and a non-extraction-treated sample, which was a sample not subjected to chloroform extraction, were subjected to measurement using a thermogravimetric analyzer (TGA) (“Thermal Analysis System TGA/DSC 3+” manufactured by METTLER TOLEDO) under the thermogravimetric analysis conditions shown in Table 2 below.

TABLE 2
Thermogravimetric analysis conditions

| Temperature | Temperature | | Retention | Atmospheric | |
|---|---|---|---|---|---|
| program | (° C.) | Heating rate | time (min) | gas | Gas flow rate |
| 1st step | 50 | — | 1 | N₂ | 50 mL/min |
| 2nd step | 50 → 700 | 50° C./min | — | N₂ | 50 mL/min |
| 3rd step | 700 | — | 5 | N₂ | 50 mL/min |
| 4th step | 700 | — | 11 | Air | 100 mL/min |

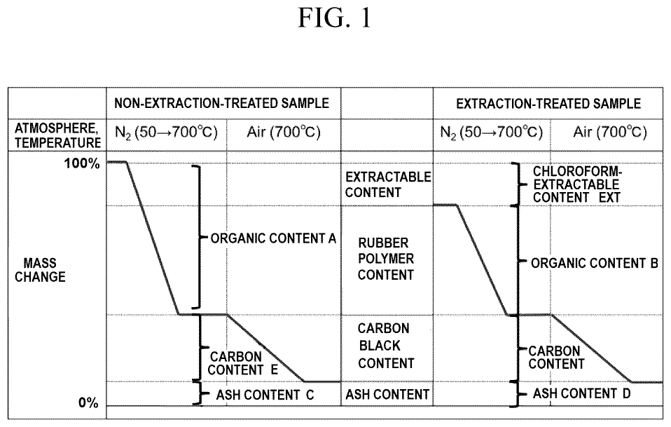

As shown in FIG. 1, a fraction of the non-extraction-treated sample lost after treatment at 700° C. in a nitrogen atmosphere was designated as organic content “A” (mass %), the residue of the non-extraction-treated sample after treatment at 700° C. in an air atmosphere was designated as ash content “C” (mass %), and a fraction of the non-extraction-treated sample lost after treatment at 700° C. in an air atmosphere was designated as carbon content “E” (mass %). In addition, a fraction of the extraction-treated sample lost after treatment at 700° C. in a nitrogen atmosphere was designated as organic content “B” (mass %), and the residue of the extraction-treated sample after treatment at 700° C. in an air atmosphere was designated as ash content “D” (mass %). There is no difference in the mass of the ash between the samples whether they were subjected to extraction or not, but the extraction makes a difference in the percentage of the ash. By using the difference between the percentages of the ash before and after extraction, the rubber polymer content in the non-extraction-treated sample is calculated by the following formula (1).

$$Rubber polymer content ( mass \% ) = B \times C / D \qquad Formula ( 1 )$$

Chloroform-extractable content Ext is calculated by the following formula (2).

$$Chloroform - extractable content Ext ( mass \% ) = A - B \times C / D \qquad Formula ( 2 )$$

Carbon black content (mass %) can be identified as the carbon content “E” in the non-extraction-treated sample.

### 2. Toluene Solubility (Sol Fraction)

Reclaimed rubbers 1 to 4 and powdered rubbers 1 and 2 were used as samples, and the mass (P) of each sample was measured. Each sample was wrapped in a wire mesh with a mesh number of 120 to 150, and the mass (Q) of each sample was measured. Each sample wrapped in the wire mesh was immersed in toluene contained in a flask for 24 hours. After immersion, each sample wrapped in the wire mesh was taken out and dried in a vacuum dryer, and the mass (T) of each sample was measured. The toluene solubility was calculated by the formula below.

$$Toluene solubility ( sol fraction ) = ( Q - T ) / P \times 100$$

### 3. Rubber Polymer Composition

Reclaimed rubbers 1 to 4 and powdered rubbers 1 and 2 were used as samples, and the percentages of styrene, butadiene, and isoprene were determined in accordance with JIS K 6231-2:2007 “Rubber-Analysis by pyrolytic gas-chromatographic methods”. The specifics are as follows. Each sample was subjected to acetone extraction as a pretreatment. More particularly, acetone-soluble ingredients were extracted using an automatic Soxhlet extractor (“E-800” manufactured by Nihon BUCHI K.K.). Extraction conditions were as specified in JIS K 6229:2015, under which 2 g of a sample was treated with a solvent acetone at 90° C. for 8 hours.

Then, 0.2 mg of the pretreated sample was wrapped in a pyrofoil, inserted into a pyrolysis-gas chromatograph (GC-2010 Plus manufactured by Shimadzu Corporation), and pyrolyzed. Thus, a pyrogram was obtained. Pyrolytic and chromatographic conditions are as follows.
Carrier gas: He
Carrier gas flow rate: 25.0 cm/s
Column type: “HP-1” manufactured by Agilent J&W
Column size: 0.25 mm×30 m×0.25 μm
Sample injection method: Split, 1/50
Sample vaporization unit temperature: 280° C.
Column bath temperature (program) 40° C. (5 min)→(heating at 10° C./min)→200° C.→(heating at 20° C./min)→280° C. (5 min)
Detector type: FID
Makeup gas type and flow rate: N2, 45 mL/min
Hydrogen gas flow rate: 40 mL/min
Air flow rate: 450 mL/min

In the pyrogram, the peak areas of styrene (ST), butadiene (BD), isoprene (IP), butadiene dimer (4VCH), and isoprene dimer (DP) were determined. In the sum of these peak areas, the percentages (%) of the peak areas of ST, BD, and IP were calculated as styrene, butadiene, and isoprene contents, respectively, using the following formulae.

$$Styrene content ( \% ) = ( ST peak area / sum of peak areas ) \times 100$$

$$Butadiene content ( \% ) = ( BD peak area / sum of peak areas ) \times 100$$

$$Isoprene content ( \% ) = ( IP peak area / sum of peak areas ) \times 100$$

The results are as shown in Table 3 below. Powdered rubbers 1 and 2, each of which was prepared simply by grinding of a vulcanized rubber without a reclamation process, had a low toluene solubility and a low sol fraction. Reclaimed rubber 4, which was prepared by a reclamation process without adding a cumarone resin as a thermoplastic resin, had a chloroform-extractable content lower than specified. In addition, reclaimed rubber 4 lacked in tackiness, was poorly cohesive, and had a low sol fraction because the SBR gelled to a higher degree and cured in the reclamation process. In contrast, reclaimed rubbers 1 and 2, which were prepared by a reclamation process including adding a thermoplastic resin as well as an oil and a peptizer, had a chloroform-extractable content within the specified range. In addition, the thermoplastic resin suppressed the gelation of the SBR, so that reclaimed rubbers 1 and 2 had a high sol fraction and possessed tackiness. Meanwhile, although reclaimed rubber 3 was prepared by a reclamation process including adding a thermoplastic resin, an overlong devulcanization process promoted the gelation of the SBR, and the sol fraction was lower than specified.

TABLE 3

| | Reclaimed | Reclaimed | Reclaimed | Reclaimed | Powdered | Powdered |
|---|---|---|---|---|---|---|
| | rubber 1 | rubber 2 | rubber 3 | rubber 4 | rubber 1 | rubber 2 |
| Source material | Vulcanizate 1 | Vulcanizate 2 | Vulcanizate 1 | Vulcanizate 1 | Vulcanizate 1 | Vulcanizate 2 |
| Devulcanization | Devulcanized | Devulcanized | Devulcanized | Devulcanized | Non- | Non- |
| | | | | | devulcanized | devulcanized |
| Use of cumarone resin | Used | Used | Used | Not used | Not used | Not used |
| in reclamation process | | | | | | |
| Sol fraction (mass %) | 28 | 30 | 20 | 15 | 16 | 13 |
| Reclaimed rubber | | | | | | |
| composition (mass %) | | | | | | |
| Rubber polymer content | 48 | 42 | 48 | 56 | 55 | 58 |
| Carbon black content | 8 | 7 | 7 | 7 | 8 | 3 |
| Ash content | 24 | 24 | 24 | 28 | 28 | 33 |
| Chloroform-extractable | 20 | 27 | 22 | 9 | 7 | 6 |
| content Ext | | | | | | |
| Total | 100 | 100 | 100 | 100 | 100 | 100 |
| Rubber polymer | | | | | | |
| composition (%) | | | | | | |
| Styrene content | 45 | 16 | 45 | 45 | 45 | 15 |
| Isoprene content | 0 | 38 | 0 | 0 | 0 | 39 |
| Butadiene content | 45 | 25 | 45 | 45 | 45 | 25 |

### Preparation of Rubber Compositions

Rubber compositions of Examples 1 to 8 and Comparative Examples 1 to 16 were prepared using the above reclaimed rubbers 1 to 4 and powdered rubbers 1 and 2 according to the formulations (parts by mass) shown in Tables 4 and 5 below. More particularly, compounding ingredients excluding sulfur and vulcanization accelerators were added to an unvulcanized rubber component and kneaded. Then, sulfur and vulcanization accelerators were added to the kneaded mixture and kneaded to prepare rubber compositions.

Each ingredient in Tables 4 and 5 is as follows.
SBR: Non-modified ESBR, “SBR 1502” manufactured by ENEOS Materials Corporation
NR: RSS #3
Silica: “TOKUSIL USG-A” manufactured by OSC Siam Silica Co., Ltd.
Silane coupling agent: “Si 75” manufactured by Evonik Japan Co., Ltd.
Carbon black: “DIABLACK N339” manufactured by Mitsubishi Chemical Group Corporation
Oil: “Process NC-140” manufactured by ENEOS Corporation
Zinc oxide: “Zinc oxide grade 2” manufactured by Mitsui Mining & Smelting Co., Ltd.
Stearic acid: “Stearic acid N-50” manufactured by NOF Corporation
Age-resister: “Nocrac 6C” manufactured by Ouchi Shinko Chemical Industrial Co., Ltd.
Sulfur: “Oil treated sulfur 150-mesh powder” manufactured by Tsurumi Chemical Industry Co., Ltd.
Vulcanization accelerator A: “SOXINOL D-G” manufactured by Sumitomo Chemical Co., Ltd
Vulcanization accelerator B: “Nocceler CZ-G” manufactured by Ouchi Shinko Chemical Industrial Co., Ltd.

A test piece of each rubber composition was prepared by vulcanization at 170° C. for 15 minutes and subjected to measurement of breaking strength and elongation at break. More particularly, a dumbbell-shaped No. 3 test piece was prepared and subjected to a tensile test performed at a tensile speed of 500 mm/min in accordance with JIS K 6251:2017 to measure tensile strength (breaking strength) and elongation at break. Table 4 shows the values for Examples and Comparative Examples expressed as index numbers assuming that the value for Comparative Example 1 is 100. Table 5 shows the values for Examples and Comparative Examples expressed as index numbers assuming that the value for Comparative Example 9 is 100. A larger index number indicates higher breaking strength and elongation at break.

TABLE 4

| | Ex. 1 | Ex. 2 | Ex. 3 | Ex. 4 |
|---|---|---|---|---|
| Formulation (parts by mass) | | | | |
| SBR | 100 | 100 | 100 | 100 |
| Silica | 50 | 50 | 50 | 50 |
| Silane coupling agent | 4 | 4 | 4 | 4 |
| Carbon black | 15 | 15 | 15 | 15 |
| Oil | 10 | 10 | 10 | 10 |
| Zinc oxide | 2 | 2 | 2 | 2 |
| Stearic acid | 2 | 2 | 2 | 2 |
| Age-resister | 2 | 2 | 2 | 2 |
| Reclaimed rubber 1 | 10 | 20 | | |
| Reclaimed rubber 2 | | | 10 | 20 |
| Reclaimed rubber 3 | | | | |
| Reclaimed rubber 4 | | | | |
| Powdered rubber 1 | | | | |
| Powdered rubber 2 | | | | |
| Sulfur | 1.8 | 1.8 | 1.8 | 1.8 |
| Vulcanization accelerator A | 1.8 | 1.8 | 1.8 | 1.8 |
| Vulcanization accelerator B | 1.3 | 1.3 | 1.3 | 1.3 |
| Evaluation (index number) | | | | |
| Breaking strength | 120 | 114 | 106 | 104 |
| Elongation at break | 114 | 105 | 113 | 110 |

| | Comp. | Comp. | Comp. | Comp. | Comp. | Comp. | Comp. | Comp. |
|---|---|---|---|---|---|---|---|---|
| | Ex. 1 | Ex. 2 | Ex. 3 | Ex. 4 | Ex. 5 | Ex. 6 | Ex. 7 | Ex. 8 |
| Formulation (parts by mass) | | | | | | | | |
| SBR | 100 | 100 | 100 | 100 | 100 | 100 | 100 | 100 |
| Silica | 50 | 50 | 50 | 50 | 50 | 50 | 50 | 50 |
| Silane coupling agent | 4 | 4 | 4 | 4 | 4 | 4 | 4 | 4 |
| Carbon black | 15 | 15 | 15 | 15 | 15 | 15 | 15 | 15 |
| Oil | 10 | 10 | 10 | 10 | 10 | 10 | 10 | 10 |
| Zinc oxide | 2 | 2 | 2 | 2 | 2 | 2 | 2 | 2 |
| Stearic acid | 2 | 2 | 2 | 2 | 2 | 2 | 2 | 2 |
| Age-resister | 2 | 2 | 2 | 2 | 2 | 2 | 2 | 2 |
| Reclaimed rubber 1 | | | | | | | | |
| Reclaimed rubber 2 | | | | | | | | |
| Reclaimed rubber 3 | 10 | 20 | | | | | | |
| Reclaimed rubber 4 | | | 10 | 20 | | | | |
| Powdered rubber 1 | | | | | 10 | 20 | | |
| Powdered rubber 2 | | | | | | | 10 | 20 |
| Sulfur | 1.8 | 1.8 | 1.8 | 1.8 | 1.8 | 1.8 | 1.8 | 1.8 |
| Vulcanization accelerator A | 1.8 | 1.8 | 1.8 | 1.8 | 1.8 | 1.8 | 1.8 | 1.8 |
| Vulcanization accelerator B | 1.3 | 1.3 | 1.3 | 1.3 | 1.3 | 1.3 | 1.3 | 1.3 |
| Evaluation (index number) | | | | | | | | |
| Breaking strength | 100 | 84 | 89 | 88 | 90 | 88 | 88 | 82 |
| Elongation at break | 100 | 87 | 86 | 84 | 83 | 84 | 84 | 79 |

TABLE 5

| | Ex. 5 | Ex. 6 | Ex. 7 | Ex. 8 |
|---|---|---|---|---|
| Formulation (parts by mass) | | | | |
| SBR | 80 | 80 | 80 | 80 |
| NR | 20 | 20 | 20 | 20 |
| Silica | 50 | 50 | 50 | 50 |
| Silane coupling agent | 5 | 5 | 5 | 5 |
| Carbon black | 15 | 15 | 15 | 15 |
| Oil | 10 | 10 | 10 | 10 |
| Zinc oxide | 2 | 2 | 2 | 2 |
| Stearic acid | 2 | 2 | 2 | 2 |
| Age-resister | 2 | 2 | 2 | 2 |
| Reclaimed rubber 1 | 10 | 20 | | |
| Reclaimed rubber 2 | | | 10 | 20 |
| Reclaimed rubber 3 | | | | |
| Reclaimed rubber 4 | | | | |
| Powdered rubber 1 | | | | |
| Powdered rubber 2 | | | | |
| Sulfur | 1.8 | 1.8 | 1.8 | 1.8 |
| Vulcanization accelerator A | 1.8 | 1.8 | 1.8 | 1.8 |
| Vulcanization accelerator B | 1.3 | 1.3 | 1.3 | 1.3 |
| Evaluation (index number) | | | | |
| Breaking strength | 120 | 113 | 122 | 108 |
| Elongation at break | 112 | 105 | 114 | 109 |

| | Comp. | Comp. | Comp. | Comp. | Comp. | Comp. | Comp. | Comp. |
|---|---|---|---|---|---|---|---|---|
| | Ex. 9 | Ex. 10 | Ex. 11 | Ex. 12 | Ex. 13 | Ex. 14 | Ex. 15 | Ex. 16 |
| Formulation (parts by mass) | | | | | | | | |
| SBR | 80 | 80 | 80 | 80 | 80 | 80 | 80 | 80 |
| NR | 20 | 20 | 20 | 20 | 20 | 20 | 20 | 20 |
| Silica | 50 | 50 | 50 | 50 | 50 | 50 | 50 | 50 |
| Silane coupling agent | 5 | 5 | 5 | 5 | 5 | 5 | 5 | 5 |
| Carbon black | 15 | 15 | 15 | 15 | 15 | 15 | 15 | 15 |
| Oil | 10 | 10 | 10 | 10 | 10 | 10 | 10 | 10 |
| Zinc oxide | 2 | 2 | 2 | 2 | 2 | 2 | 2 | 2 |
| Stearic acid | 2 | 2 | 2 | 2 | 2 | 2 | 2 | 2 |
| Age-resister | 2 | 2 | 2 | 2 | 2 | 2 | 2 | 2 |
| Reclaimed rubber 1 | | | | | | | | |
| Reclaimed rubber 2 | | | | | | | | |
| Reclaimed rubber 3 | 10 | 20 | | | | | | |
| Reclaimed rubber 4 | | | 10 | 20 | | | | |
| Powdered rubber 1 | | | | | 10 | 20 | | |
| Powdered rubber 2 | | | | | | | 10 | 20 |
| Sulfur | 1.8 | 1.8 | 1.8 | 1.8 | 1.8 | 1.8 | 1.8 | 1.8 |
| Vulcanization accelerator A | 1.8 | 1.8 | 1.8 | 1.8 | 1.8 | 1.8 | 1.8 | 1.8 |
| Vulcanization accelerator B | 1.3 | 1.3 | 1.3 | 1.3 | 1.3 | 1.3 | 1.3 | 1.3 |
| Evaluation (index number) | | | | | | | | |
| Breaking strength | 100 | 86 | 95 | 90 | 95 | 87 | 96 | 86 |
| Elongation at break | 100 | 87 | 93 | 92 | 96 | 85 | 97 | 79 |

The results are as shown in Tables 4 and 5. Table 4 shows examples in which the unvulcanized rubber component is an SBR alone. Comparative Examples 5 to 8 used powdered rubber 1 or 2, which was prepared without a reclamation process, and the results showed a poor breaking strength and elongation at break. Comparative Examples 3 and 4 used reclaimed rubber 4, which was prepared by a reclamation process using an oil and a peptizer. Reclaimed rubber 4 was poorly cohesive due to a higher degree of gelation and thus had a poor miscibility with the unvulcanized rubber component. As a result, Comparative Examples 3 and 4 showed little improvement in breaking strength and elongation at break compared with Comparative Examples 5 to 8. In contrast, Examples 1 to 4 used reclaimed rubber 1 or 2, which was prepared by a reclamation process using a thermoplastic resin as well as an oil and a peptizer. Reclaimed rubbers 1 and 2 were suppressed from gelling and possessed tackiness. As a result, Examples 1 to 4 showed a good miscibility of the reclaimed rubber and the unvulcanized rubber component, and a marked improvement in breaking strength and elongation at break compared with Comparative Examples 5 to 8. Comparative Examples 1 and 2 used reclaimed rubber 3, which had a chloroform-extractable content within the specified range but had a low sol fraction, and the results showed that improvement in breaking strength and elongation at break was not necessarily sufficient in comparison with Comparative Examples 5 to 8.

Table 5 shows examples in which the unvulcanized rubber component is a combination of an SBR and an NR. Examples 5 to 8, which used reclaimed rubber 1 or 2, showed a marked improvement in breaking strength and elongation at break compared with Comparative Examples 9 to 16, which used reclaimed rubber 3 or 4 or powdered rubber 1 or 2.

As for numerical ranges set forth in the description, the upper and lower limits for each range can be used in any combination, and all the combinations are regarded as delimiting preferable numerical ranges encompassed in the description. The numerical range represented by “X to Y” means X or greater and Y or smaller.

What is claimed is:

1. A rubber composition comprising:
an unvulcanized rubber component, and
0.1 to 30 parts by mass of a reclaimed rubber containing a styrene-butadiene rubber relative to 100 parts by mass of the unvulcanized rubber component,
wherein the reclaimed rubber has an amount of chloroform-extractable matter by Soxhlet extraction of 15 to 30 mass %, the chloroform-extractable matter containing an oil and a thermoplastic resin, and wherein the reclaimed rubber has a toluene solubility of 25 mass % or more.

2. The rubber composition according to claim 1, wherein a rubber polymer in the reclaimed rubber have a styrene content of 10% to 60% in terms of peak area percentage as determined by pyrolysis-gas chromatography in accordance with JIS K 6231-2:2007.

3. The rubber composition according to claim 2, wherein the rubber polymer in the reclaimed rubber have a butadiene content of 15% to 60% in terms of peak area percentage as determined by pyrolysis-gas chromatography in accordance with JIS K 6231-2:2007.

4. The rubber composition according to claim 2, wherein the rubber polymer in the reclaimed rubber have an isoprene content of 0% to 50% in terms of peak area percentage as determined by pyrolysis-gas chromatography in accordance with JIS K 6231-2:2007.

5. The rubber composition according to claim 1, further comprising 20 to 150 parts by mass of a reinforcing filler relative to 100 parts by mass of the unvulcanized rubber component.

6. The rubber composition according to claim 1, wherein the thermoplastic resin is at least one tackifier resin selected from the group consisting of cumarone-based resin, petroleum resin, terpene-based resin, and rosin-based resin.

7. The rubber composition according to claim 1, wherein the reclaimed rubber has a rubber polymer content of 30 to 60 mass % as determined by thermogravimetric analysis (TGA).

8. The rubber composition according to claim 7, wherein the reclaimed rubber has a carbon black content of 3 to 20 mass % as determined by thermogravimetric analysis (TGA).

9. The rubber composition according to claim 7, wherein the reclaimed rubber has an ash content of 10 to 35 mass % as determined by thermogravimetric analysis (TGA).

10. The rubber composition according to claim 1, wherein the 100 parts by mass of the unvulcanized rubber component include 20 to 100 parts by mass of a styrene-butadiene rubber.

11. The rubber composition according to claim 1, wherein the 100 parts by mass of the unvulcanized rubber component include 50 to 90 parts by mass of a styrene-butadiene rubber and 10 to 50 parts by mass of a natural rubber and/or a butadiene rubber.

12. A tire comprising a vulcanized rubber formed by vulcanization of the rubber composition according to claim 1.
